(19) United States
(12) Patent Application Publication
(10) Pub. No.: US 2007/0007323 A1
(43) Pub. Date: Jan. 11, 2007

(54) STANDOFF STRUCTURES FOR SURFACE MOUNT COMPONENTS

(75) Inventors: David J. Russell, Owego, NY (US); Luc Guerin, Quebec (CA); Mario J. Interrante, New Paltz, NY (US); Steven P. Ostrander, Poughkeepsie, NY (US); Anna N. Spencer, Jeffersonville, VT (US); Van Thanh Truong, Quebec (CA)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/160,702

(22) Filed: Jul. 6, 2005

(51) Int. Cl. B23K 31/02; B23K 35/12

(52) U.S. Cl. 228/246; 228/180.22

(57) ABSTRACT

Increasing standoff height for surface mount components mounted to a laminate by image screening at least one standoff structure in a footprint area on the laminate surface. The standoff structure may comprise a filled epoxy and curing agents and may be cured by thermal treatment or by exposure to actinic radiation. The use of legend ink as a standoff structure offers a method and a structure for improving component standoff height without additional processing operations or cost.

### BACKGROUND OF THE INVENTION

1. Technical Field

The invention relates to semiconductor device packaging and, more particularly, to techniques for surface mount technology (SMT) for mounting SMT components to substrates, and addressing the issue of solder joint fatigue.

2. Related Art

With the trend for higher wiring density and improved electrical performance in flip chip plastic ball grid array (FCPBGA) laminate chip carriers, it is desirable to place passive components, such as capacitors, on the chip carriers as close to the chip as possible. Recent developments in capacitor technology have resulted in small multi-terminal ceramic capacitors. These capacitors are typically soldered directly onto copper (Cu) pads on the FCPBGA laminates. Typical multi-terminal capacitors have 6-10 terminals, requiring a like number of solder joints, per capacitor. The capacitor may be on the top or the bottom of the laminate chip carrier. (The “laminate” chip carrier may also be referred to as an “organic” substrate.)

Surface Mount Technology (SMT) is a technique for populating hybrids, multichip modules, and circuit boards, in which packaged components are mounted directly onto the surface of the substrate. A layer of solder paste is screen printed onto the pads and the components are attached by pushing their leads into the paste. When all of the components have been attached, the solder paste is melted using either reflow soldering or vapor-phase soldering.

A surface mount device (SMD) or component is an electronic component, ranging from discrete passive components, such as chip resistors and chip capacitors, to VLSI (very large scale integration) chips, attached to the surface of a substrate such as a printed circuit board or a ball grid array (BGA) package substrate, either directly or through a surface-mount connector, rather than by means of wires, leads or holes in the board.

Flip Chip technology is a type of SMT, and refers to situations where a device—typically a device having solder bumps—is mounted face-down (active side down) onto a substrate.

Thermal expansion mismatch between organic substrates and surface mount components (e.g. Barium Titanate (BaTiO₃) based ceramic capacitor) causes solder fatigue of component interconnect during thermal cycling and limits reliability of assembled module.

Insufficient component standoff height of conventional solder joint results in high solder strain and limits solder fatigue life.

Localized impingement of intermetallic compounds between the component terminal and the substrate pad limits further solder ductility and exacerbates the solder fatigue life problem in low standoff height solder joints.

Component cracking due to ‘solder buttress effect’ precludes the usual solder volume optimization approach to improving interconnect fatigue life by imposing a upper bound on useful solder volume and limits fatigue life on solder interconnect.

FIG. 1 is a cross-sectional view of a surface mount component 100 soldered to a substrate 120, according to the prior art. The component 100 is, for example, a passive component such as capacitor having a ceramic body portion 102, and a pair of terminals (surface mount terminations, or “tabs”) 104. Each terminal is generally C-shaped, and typically extends around the side of the component body to under the bottom (as viewed) and over the top (as viewed) surfaces of the component body. The component terminals are solderable (solder wettable).

The surface mount component is suitably an interdigitated capacitor (IDC) which is a ceramic chip capacitor having multiple pairs of terminals and arranged internally to reduce parasitic inductance. IDC chip capacitors are available from AVX Corp. (A Kyocera Group company).

The substrate (also referred to as “laminate”) 120 is an interconnect (wiring) substrate comprising, for example, an organic substrate 122 having metal contact (terminal) pads 124 having areas which are exposed on a surface (top, as viewed) of the substrate 122 for connecting to (by soldering) respective terminals 104 of the surface mount component 100. The exposed areas of the pads 124 is defined by openings in a solder mask layer 126. The exposed areas of the pads 124 are sized and spaced to align with the terminals 104 of the surface mount component 100.

For example, the overall size of the surface mount component 100 is 2.03 mm×1.27 mm. For example, the exposed areas of the contact pads 124 are rectangular, measuring 0.28 mm×0.64 mm.

The surface mount component 100 is soldered to the substrate 120. Solder interconnects (joints, fillets) 130 are shown in FIG. 1.

As is evident in FIG. 1, the resulting assembly exhibits low component “standoff height” (SH1), which (for purposes of this disclosure) is defined as the distance between the bottom surface of a component terminal 104 and the top surface of the corresponding contact pad 124.

As is known, low standoff height contributes to high solder strains and limits fatigue life on the solder interconnect. It is therefore known to increase standoff height between a surface mount component and the substrate to which it is mounted (connected).

U.S. Pat. No. 6,445,589 ('589 patent) discloses a method of extending life expectancy of surface mount components in electronic assemblies wherein a distance between the printed circuit board and the surface mount component is held to a predetermined distance defined as the stand-off height. The relationship between the stand-off height and the life expectancy of the component is directly proportional. A larger stand-off height translates into a longer life expectancy. The stand-off height is limited only by manufacturing constraints, such as process limitations and cost concerns. The stand-off height is set to a predetermined dimension by way of a spacer positioned between the surface mount component and the printed circuit board. The disclosure of the '589 patent relates to surface mount components and more particularly to a method for extending the life expectancy of surface mount components by improving the reliability of a solder joint.

As disclosed in the '589 patent, a distance between the printed circuit board and the surface mount component is held to a predetermined distance defined as the stand-off height. The stand-off height is set to a predetermined dimension by way of a spacer positioned between the surface mount component and the printed circuit board. With reference to FIGS. 3A-3F, a spacer (28), or tab, is strategically placed between the surface mount component (10) and the top surface of the printed circuit board (12). The spacer has predetermined dimensions such that its placement in relation to the surface mount component defines the stand-off height dimension. Adhesive material (30), or other suitable material, is deposited on the printed circuit board so that the spacer will adhere to the printed circuit board as shown in FIG. 3B. The adhesive need only be strong enough to hold the spacer temporarily until the solder process is complete, at which time the solder joint provides the permanent attachment of the surface mount component to the printed circuit board at the predetermined stand-off height. Referring to FIG. 3B, the spacer is attached to the circuit board by the adhesive material (30). Additional adhesive material (32) is deposited on the spacer as shown in FIG. 3C. The surface mount component is positioned above the spacer, as shown in FIG. 3D and then attached as shown in FIG. 3E to the spacer and temporarily held in place by the adhesive material (32). The stand-off height is determined by the height of the spacer.

As disclosed in the '589 patent, the spacer (28) may be of a plastic material, or any other suitable material, preferably having a low cost. The adhesive material (30, 32) need only be strong enough to hold the spacer (28) in place temporarily until the solder joint (14) is formed and solidified. Once the solder joints (14) have formed, the spacer (28) is secure between the printed circuit board (12) and the surface mount component (10).

As disclosed in the '589 patent, in another embodiment, the spacer is integral to the surface mount component. The spacer is a tab or similar structure that is part of the exterior of the surface mount component. In this embodiment it is not necessary to apply adhesive material between the surface mount component and the spacer.

As disclosed in the '589 patent, in another embodiment, the spacer is integral to the printed circuit board. The spacer is an extension of the printed circuit board. In this embodiment it is not necessary to apply adhesive material between the printed circuit board and the spacer.

FIG. 2 corresponds to FIG. 3F of the '589 patent, and shows a spacer 228 (compare 28) disposed between the surface mount component 210 (compare 10) and the top surface of the printed circuit board 212 (compare 12). A stand-off height (16) is defined as the distance between the bottom surface (18) of the surface mount component 210 (10) and the top surface (20) of a mounting pad 222 (compare 22) on the surface of the printed circuit board 212 (12). Solder joints 214 (compare 14) are shown.

The '589 patent teaches having a standoff element (spacer) disposed between the surface mount component and the interconnection substrate (printed circuit board) to which the surface mount component is mounted. The shortcomings of the '589 patent technique, and differences between the technique of the '589 patent and those of the present invention will be discussed hereinbelow.

A typical process for capacitor attach is as follows. Solder paste is screened onto the chip carrier and reflowed to form “presolder”. The presolder height above the surface of the laminate solder mask surface is 0-60 um (micrometers), preferably 20-50 um. At the assembly site, flux is applied to the laminate and the capacitors are placed onto the presolder and reflowed. The solder wets the connecting tabs on the capacitor, forming solder joints. In the final assembly the capacitor is mounted with the bottom above the solder mask surface, supported by the solder joints, with a 2-10 um gap between the solder mask surface and the bottom of the capacitor. While initially the capacitor is held at a height of 20-50 um by the presolder height, the final gap is significantly less due to the formation of a solder fillet and the surface tension of the molten solder pulling the capacitor closer to the laminate surface. It is not evident whether the '589 patent contemplates this process, as discussed in greater detail hereinbelow.

With reference to FIG. 1, the solder joint has two regions. “Region 1” is the portion of solder directly between the capacitor tab 104 and the laminate pad 124. “Region 2” is the generally wedge-shaped mass of solder (solder fillet) 130 which is next to the capacitor, resulting from the solder wetting up the side of the capacitor. Typically the solder fillet is considered to be the key factor to optimizing the solder joint fatigue life in thermal cycle stress testing.

Another trend in the industry is to replace Sn/Pb (tin/lead) solder with Pb free (lead free) solders. Examples of Pb free solder alloys are SnAgCu (or “SAC“; tin-silver-copper) alloys and SnCu (tin-copper) compositions. A typical SAC alloy contains 3.0% Ag. A typical SnCu composition contains 99.3% Sn and 0.7% Cu. It is known in the industry that SAC alloy solders are less ductile than traditional SnPb alloys.

Yet another trend in the industry is to change from a NiAu (Nickel Gold) plated capacitor pad on the FCPBGA chip carrier to a Cu surface.

One problem associated with these changes is the formation of a SnCu (tin copper) intermetallic near the SAC/Cu interface due to diffusion of the Cu from the FCPBGA pad into the SAC solder. It is known in the industry that these intermetallic compounds are less ductile than the SnPb or SAC alloys.

Typical reliability testing in the industry includes thermal cycling of an assembled module, such as in the range of −55° C. to 125° C. In thermal cycling, the primary failure mode for capacitors is solder joint fatigue cracking. This is driven primarily by the CTE (coefficient of thermal expansion) mismatch between the low CTE ceramic capacitor and the high CTE organic laminate. The fatigue life is essentially determined by the ductility of the solder joint and the height of the solder joint. As is known, more ductility is better, more height is better. Solder undergoes some plastic deformation upon thermal cycling, however some damage occurs. With additional thermal cycling, the damage can accumulate until it reaches a point where the solder joint cracks, leading to failure of the assembly (or module).

In the current technology, the gap (standoff height, SH) between the capacitor tab and the laminate pad is sufficiently small such that Region 1 (between the capacitor tab and the laminate pad) is primarily composed of SnCu intermetallic. This region is therefore more brittle and will tend to crack sooner in thermal cycling. Once a crack initiates in this region, it easily propagates through the solder fillet and results in an open circuit. It is desirable to improve the fatigue performance in the region 1 of the solder joint.

### SUMMARY OF THE INVENTION

It is a general aspect of the invention to improve surface mount interconnect reliability. More specifically, it is an aspect of the invention to improve the thermal cycle fatigue life of multi-terminal capacitor solder joints. Since the choice of solder alloys are limited, and the formation of intermetallics is dictated by the alloy composition and laminate pad surface finish, one solution is to increase the height of Region 1 (between the capacitor tab and the laminate pad) in the solder joint, as discussed above. This results in an increase volume of the more ductile solder alloy, allowing more plastic deformation before the joint fractures. An improved technique for increasing the solder volume is disclosed herein.

According to the invention, generally, a technique is provided to increase the gap (in Region 1) between the laminate surface and the multi-terminal capacitor, thus increasing the amount of the more ductile alloy in the solder joint (in Region 1) and offering an improved thermal cycle fatigue performance. The invention is particularly well suited to multi-terminal surface mount components such as multiple-terminal capacitors.

The invention generally comprises formation of a physical standoff structure on the substrate surface within the component footprint to increase the spacing between component-termination and substrate-pad resulting in improved interconnect geometry and improved solder fatigue life.

The standoff structure comprises a dielectric material (e.g. filled epoxy, solder mask material, etc).

The standoff structure is applied by selective deposition (e.g., screen printed dots, lines, etc) to minimize substrate in-plane stress/warping, and to facilitate solder flux cleaning beneath the component.

The standoff structure has a CTE greater than solder to allow component-to-substrate clearance on cool-down after soldering.

A preferred material for the standoff structure is Legend Ink (also know as nomenclature ink, silk screen ink, or white ID) consisting of a filled epoxy and curing agent are already typically applied to the surface of organic substrates for module marking (e.g. module serial number ink). Utilization of legend ink for the standoff structure would allow improved component standoff without additional processing steps.

An exemplary process flow is:
1) Laminate fabrication through the solder mask process using usual fabrication techniques.
2) Modification of the legend ink screen image to print legend ink in the shape of dots, lines, or other desirable shapes on top of the laminate solder mask surface in the area which will be directly under the IDC capacitor.
3) Apply and cure legend ink using normal processing procedures.
4) Apply and reflow presolder using normal processing procedures.
5) Assemble multi-terminal capacitors using normal assembly processes as follows:
   a. apply flux to the presolder areas for capacitor joining;
   b. place the multi-terminal capacitor according to normal assembly procedures;
   c. reflow according to normal assembly procedures; and
   d. wash/clean according to normal assembly procedures.

The concept of improving solder fatigue life through increased component standoff height is well understood and demonstrated in as prior art.

The described invention offers a method and a structure for improving component standoff height without additional processing operations or cost.

According to the invention, a method of mounting a surface mount component to a substrate comprises forming at least one standoff element in a footprint area on the substrate where the surface mount component will be mounted. The contact pads on the substrate extend at least partially into the footprint area; and there is a central portion of the footprint area which is free of contact pads.

According to the invention, a standoff structure for spacing a surface mount component from a substrate comprises legend ink printed on the substrate in a footprint are under the surface mount component. The standoff structure may comprise one or more standoff elements in the form of cylinders or hemispherical solids, or dots. The standoff structure may comprise four standoff elements disposed at respective four corners of a central portion of the footprint area. The standoff structure may comprise three standoff elements, two of which are disposed at two corners of one long side of a central portion of the footprint area, the third of which is disposed midway along an opposite long side of the central portion of the footprint area. The standoff structure may comprise two standoff elements disposed at two opposite sides of the footprint area, for supporting opposite edges of the surface mount component. The standoff structure may comprise one standoff element, which is a solid structure in the form of a cruciform, disposed in the central portion of the footprint area.

According to the invention, a method of increasing standoff height for surface mount components mounted to a laminate comprises applying by an image screening process at least one standoff structure in a footprint area on the laminate surface. The standoff structure may comprise a filled epoxy and curing agents and may be cured by thermal treatment or by exposure to actinic radiation.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

FIG. 1 is a cross-sectional view of a surface mount component soldered to a substrate, according to the prior art.

FIG. 2 is a cross-sectional view of a surface mount component soldered to a substrate, according to the prior art.

FIG. 3 is a cross-sectional view of a surface mount component soldered to a substrate, according to an embodiment of the invention.

FIGS. 4, 5, 6 and 7 are partial plan views of exemplary embodiments of interconnection substrates having standoff elements, according to the invention.

### DETAILED DESCRIPTION OF THE INVENTION

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) may be used to identify elements. If legends are provided, they are intended merely as an aid to the reader, and should not in any way be interpreted as limiting.

The invention is generally directed to improved solder fatigue life through decreased interconnect strain with improved component standoff.

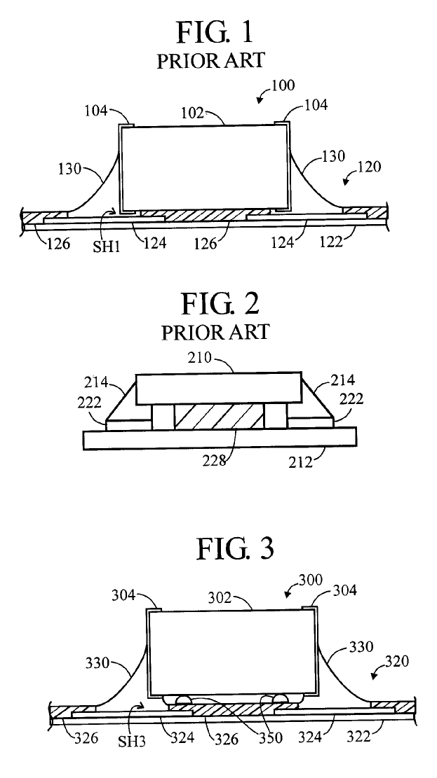

FIG. 3 illustrates an embodiment of the invention. The FIG. 3 embodiment is essentially the same as the FIG. 1 showing of prior art, with the exception that a number of discrete standoff elements 350 have been added, atop the solder mask layer 326 (compare 126), as discussed in greater detail hereinbelow.

FIG. 3 is a cross-sectional view of a surface mount component 300 (compare 100) soldered to a substrate 320 (compare 120), according to an embodiment of the invention. The component 300 is, for example, a passive component such as capacitor having a ceramic body portion 302 (compare 102), and a pair of terminals (surface mount terminations, or “tabs”) 304 (compare 104). Each terminal is generally C-shaped, and extends around the side of the component body to under the bottom (as viewed) and over the top (as viewed) surfaces of the component body. The terminals are solderable (solder wettable).

The surface mount component is suitably an interdigitated capacitor (IDC) which is a ceramic chip capacitor having multiple pairs of terminals, such as the aforementioned IDC chip capacitors from AVX Corp.

The substrate (also referred to herein as “laminate”, or “organic”) 320 is an interconnect (wiring) substrate comprising, for example, an organic substrate 322 (compare 122) having metal contact (terminal) pads 324 (compare 124) having areas which are exposed on a surface (top, as viewed) of the substrate 122 for connecting to (by soldering) respective terminals 104 of the surface mount component 100. The exposed areas of the pads 124 is defined by openings in a solder mask layer 126. The exposed areas of the pads 124 are sized and spaced to align with the terminals 104 of the surface mount component.

A difference between the FIG. 3 embodiment and the FIG. 1 prior art is the addition of the aforementioned standoff elements, atop the solder mask 326.

The surface mount component 300 is soldered to the substrate 320. Solder interconnects (fillets, joints) 330 (compare 130) are shown in the FIG. 3.

As is evident in FIG. 3, the resulting assembly exhibits increased component “standoff height” (SH3) between the bottom surface of the component terminal 304 and the top surface of the corresponding contact pad 324.

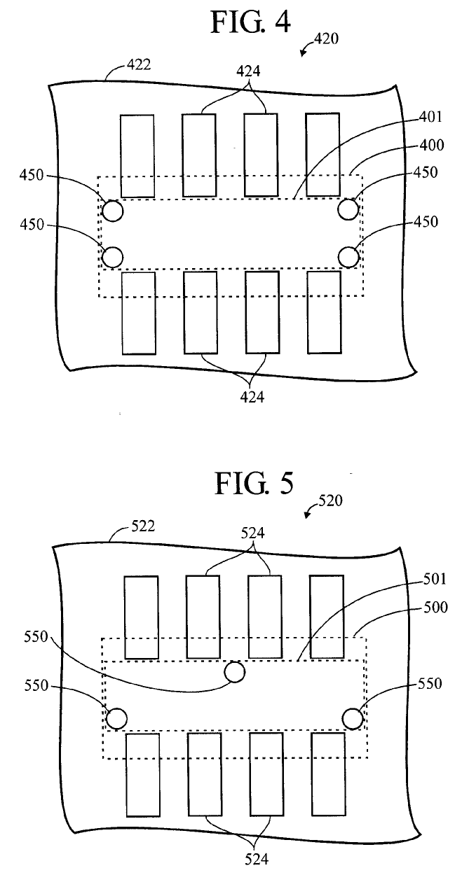

FIGS. 4, 5, 6 and 7 are partial plan views of exemplary embodiments of interconnection substrates 420, 520, 620 and 720, respectively, having standoff elements 450, 550, 650 and 750, respectively, according to the invention.

The FIG. 4 interconnection substrate 420 comprises a substrate 422 and a plurality of contact pads 424 (compare 124, 324). Eight contact pads are shown, in two rows of four. The outline (solid line) of each individual contact pad is representative of the area of the contact pad that is exposed through an opening (described above, see FIG. 3) in the solder mask (126, 326). The exposed areas of the contact pads 424 are sized and spaced to align with the terminals (104, 304) of the surface mount component (100, 300), as described above. The surface mount component (100, 300) is not shown, per se, but it's outline (or footprint) is indicated by the dashed line bordering a rectangular area 400 which comprises the exposed areas of the contact pads 424. Surface mount components typically have a rectangular footprint. Note that the contact pads 424 extend partially into the rectangular area 400, from opposite sides thereof, and there is a central portion 401 (dashed line) of the rectangular area 400 which is not populated by (not encroached by, or free of) by contact pads.

In this embodiment, the standoff elements 450 are solid structures in the form of cylinders (on end) or hemispherical solids, or dots, or the like having a height which is the standoff height (SH4) and an area (A4) on the surface of the substrate. The aggregate (n×A4) of all the individual standoff structure areas A4 is relatively small (such as less than 50%, including less than 30%, less than 20% and less than 10%) as compared with the area of the central portion 401 of the rectangular area 400.

In this embodiment, there are four (n=4) standoff elements 450, disposed at respective four corners of the central portion of the rectangular area 401, just inboard (inward) of the contact pads 424, as indicated by the broken lines. The standoff elements, and techniques for forming the standoff elements is described in greater detail hereinbelow.

The FIG. 5 interconnection substrate 520 comprises a substrate 522 and a plurality of contact pads 524 (compare 124, 324, 424). Eight contact pads are shown, in two rows of four. The outline (solid line) of each individual contact pad is representative of the area of the contact pad that is exposed through an opening (described above, see FIG. 3) in the solder mask (126, 326). The exposed areas of the contact pads 524 are sized and spaced to align with the terminals (104, 304) of the surface mount component (100, 300), as described above. The surface mount component (100, 300) is not shown, per se, but it's outline (or footprint) is indicated by the dashed line bordering a rectangular area 500 which comprises the exposed areas of the contact pads 524. Surface mount components typically have a rectangular footprint. Note that the contact pads 524 extend partially into the rectangular area 500, from opposite sides thereof, and there is a central portion 501 (dashed line) of the rectangular area 500 which has an area CP5 and which is not populated (encroached upon) by contact pads 524.

In this embodiment, the standoff elements 550 are solid structures in the form of cylinders (on end) or hemispherical solids, or dots, or the like having a height which is the standoff height (SH5) and an area (A5) on the surface of the substrate. The aggregate (n×A5) of all the individual standoff structure areas A5 is relatively small (such as less than 50%, including less than 30%, less than 20% and less than 10%) as compared with the area of the central portion 501 of the rectangular area 500.

In this embodiment, there are three (n=3) standoff elements 550, two of which are disposed at two corners of one long side of the rectangular area 501, just inboard of the contact pads 524, as indicated by the broken lines, the third of which is disposed midway along an opposite long side of the rectangular area 501, just inboard of the contact pads. The standoff elements, and techniques for forming the standoff elements is described in greater detail hereinbelow.

The embodiments of FIGS. 4 and 5 have in common that they both employ at least 3 separate and distinct standoff elements 450 and 550, respectively, to increase the standoff height of the surface mount component, and reap the benefits resulting therefrom, including the fact that each individual standoff element is extremely small ((A4 or A5)/(the area of 401 or 501) as contrasted with the area of the central portion 401 or 501 of the respective footprint area 400 or 500, respectively. Also, due to the arrangement (physical layout) of the standoff elements, and there being at least 3, the capacitor is well supported without tilting. While it is somewhat easier to make only one or two standoff elements, at least three provides this benefit. Also, in both of the exemplary embodiments of FIGS. 4 and 5, the standoff elements 450 and 550 can be formed as hemispherical dots.

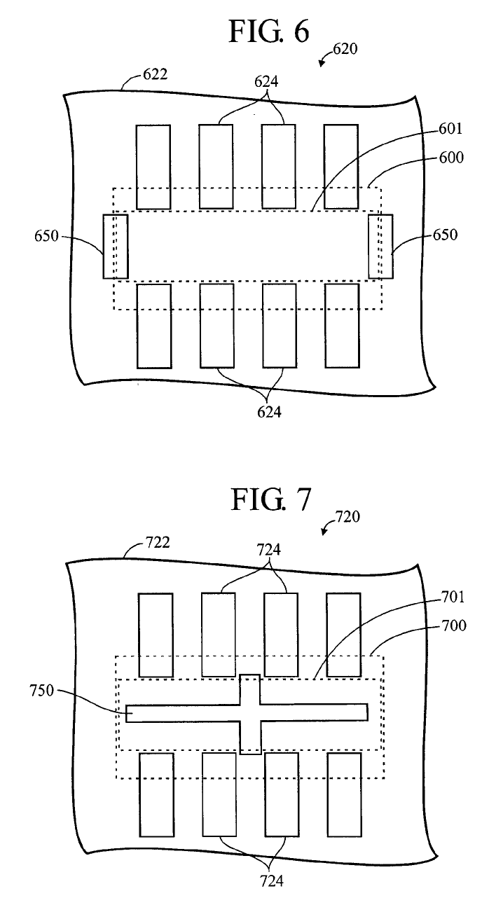

The FIG. 6 interconnection substrate 620 comprises a substrate 622 and a plurality of contact pads 624 (compare 124, 324, 424, 524). Eight contact pads are shown, in two rows of four. The outline (solid line) of each individual contact pad is representative of the area of the contact pad that is exposed through an opening (described above, see FIG. 3) in the solder mask (126, 326). The exposed areas of the contact pads 624 are sized and spaced to align with the terminals (104, 304) of the surface mount component (100, 300), as described above. The surface mount component (100, 300) is not shown, per se, but it's outline (or footprint) is indicated by the dashed line bordering a rectangular area 600 which comprises the exposed areas of the contact pads 624. Surface mount components typically have a rectangular footprint. Note that the contact pads 624 extend partially into the rectangular area 600, from opposite sides thereof, and there is a central portion 601 (dashed line) of the rectangular area 600 which has an area CP6 and which is not populated (encroached upon) by contact pads 624.

In this embodiment, the standoff elements 650 are solid structures in the form of rectangular prisms (long blocks) or half-cylinders, laying on their sides and having a height which is the standoff height (SH4) and an area (A6) on the surface of the substrate.

In this embodiment, there are two (n=2) standoff elements 650, disposed at two opposite sides of the footprint area 600 which are not encroached by contact pads 624 and which are between the other two opposite sides which the contact pads 624 encroach. Basically, these two standoff elements 650 are going to support to opposite edges of the surface mount component. The standoff elements, and techniques for forming the standoff elements is described in greater detail hereinbelow.

This embodiment illustrates an aspect of the flexibility and robustness of the technique of the present invention - for example, that the standoff structure can extend from within the footprint area 600 to without the footprint area 600, providing the greatest possible moment for supporting the surface mount component at its edges.

The FIG. 7 interconnection substrate 720 comprises a substrate 722 and a plurality of contact pads 724 (compare 124, 324, 424, 524, 624). Eight contact pads are shown, in two rows of four. The outline (solid line) of each individual contact pad is representative of the area of the contact pad that is exposed through an opening (described above, see FIG. 3) in the solder mask (126, 326). The exposed areas of the contact pads 724 are sized and spaced to align with the terminals (104, 304) of the surface mount component (100, 300), as described above. The surface mount component (100, 300) is not shown, per se, but it's outline (or footprint) is indicated by the dashed line bordering a rectangular area 700 which comprises the exposed areas of the contact pads 724. Surface mount components typically have a rectangular footprint. Note that the contact pads 724 extend partially into the rectangular area 700, from opposite sides thereof, and there is a central portion 701 (dashed line) of the rectangular area 700 which has an area CP7 and which is not populated (encroached upon) by contact pads 724.

In this embodiment, there is a single (n=1) standoff element 750, which is a solid structure in the form of a cruciform, disposed in the central area 701. The long arms of the cruciform are aligned with the long dimension of the rectangular areas 700 and 701 and, although not illustrated, could extend beyond the perimeter of the rectangular area 700 in a manner similar to the standoff elements 650 (FIG. 6). The short arms of the cruciform are aligned with the short dimension of the rectangular areas 700 and 701 and can extend (as shown) to within gaps between two adjacent contact pads 724. The standoff element has an area A7 which is relatively small (such as less than 50%, including less than 30%, less than 20% and less than 10%) as compared with the area of the central portion 701 of the rectangular area 700.

This embodiment illustrates an aspect of the flexibility and robustness of the technique of the present invention—for example, that the standoff structure can extend beyond the central area 701 into a space which is, for example, between two contact pads 724 (i.e., between two adjacent contact pads on the same side of the footprint area).

As described hereinabove, to increase the standoff gap (height), it is desirable to provide a mechanical stand-off between the laminate (interconnect substrate) surface and the capacitor (surface mount component) to control (increase) the minimum solder thickness in Region 1 (between the capacitor terminal and the substrate pad).

According to an embodiment of the invention, generally, a standoff structure (for example, the standoff elements 450, 550, 650 and 750, described hereinabove) is provided by applying a material on top of the laminate surface, the material having a controllable and appropriate thickness. A good material for this is the legend ink (also know as nomenclature ink, silk screen ink, or “white ID”). These inks are commercially available and consist of (comprise) a filled epoxy and curing agents. Legend inks can be cured by thermal treatment or by exposure to actinic radiation such as UV (ultraviolet) light. Legend ink is typically used in the printed circuit board and laminate chip carrier fabrication process to identify specific locations on a panel, provide lot number identification, date codes, etc. Since the legend ink is a common process step in the laminate fabrication, the present invention does not require any new processing steps, cycle time additions, or costs to be added.

The application of legend inks can be accomplished by several methods known in the art, but is typically done by image screening. The shape of the ink when applied may consist of dots, lines, shapes, alphanumeric characters, etc. The height of the legend ink is influenced by the rheology of the ink, the screening process used, and the width of the shape. The legend ink height (thickness) is suitably between 16 μm and 70 μm, and more typically between 16 μm and 30 μm, and the legend ink is easily printed onto the solder mask (326).

An advantage of using legend ink is that the legend ink standoff will be processed during FCBGA laminate fabrication (no cost adder), providing cost and cycle time savings, as compared with the prior art.

A flux is used in the process of attaching the capacitor (surface mount component) to ensure wetting of the solder to the capacitor tab. A variety of fluxes may be used, but typically a water soluble flux is used. Since residual flux can create a reliability concern, in the assembly process there is typically a wash step after assembly to remove traces of residual flux. An advantage of the invention is that washing (cleaning) of residual flux can be enhanced by increasing the gap in Region 1 between the capacitor and the laminate, and also by the amount of open area. As demonstrated by the embodiments of FIGS. 4-7, a variety of standoff element shapes can readily be implemented, and flux removal can be accommodated without sacrificing the standoff structure's principal function of increasing standoff height (SH).

The legend ink, and the solder mask upon which it is applied, have higher CTEs than the copper contact pad or the solder. The solder melting point is in the 183-212 degree-C temperature range, depending on the alloy used. As a result, when the solder wets the IDC tabs and pulls the capacitor to the surface, the bottom of the capacitor will be in contact with the legend ink (standoff structure). Since the legend ink has a higher CTE, upon cooling from the solder alloy solidification temperature to room temperature, the ink will contract more, providing a gap between the capacitor and the ink. Since thermal cycling is done with a peak temperature less than the melting point of the solder, the solder mask and legend ink standoff structure will not expand enough such that the legend ink standoff structure makes contact with the capacitor (which could impart additional stress on the capacitor).

The invention generally comprises printing a physical structure on the surface of the substrate which will provide standoff between the substrate and the capacitor, and advantageously utilizes existing materials and steps to achieve this. An appropriate material is legend ink which is normally used to label substrates. And an appropriate step is the screen printing step which is used to apply the legend ink. The invention generally comprises simply modifying the screen to as to print standoff structures in desired locations on the surface of the substrate.

The general idea is to not impose stress on the capacitor (surface mount component) and the associated solder joint. Apparently, from the description set forth in the 598 patent, there is a problem. The general idea is to provide a solder cushion capacitor and laminate to minimize the CTE mismatch. Since legend ink is not contacting the capacitor after solder joining is completed, the whole CTE mismatch problem goes away.

Increased solder height between the FCPBGA laminate pad and IDC capacitor tab is provided as follows:
1) laminate fabrication through to the solder mask process using usual (conventional) fabrication techniques.
2) modification of the legend ink screen image to print legend ink in the shape of dots, lines, or other desirable shapes on top of the laminate solder mask surface in the area which will be directly under the IDC capacitor.
3) Apply and cure legend ink using normal (conventional) processing procedures.
4) apply and reflow presolder using normal (conventional) processing procedures.
5) Assemble multi-terminal capacitors using normal (conventional) assembly processes as follows:
   a. apply flux to the presolder areas for capacitor joining;
   b. place the multi-terminal capacitor according to normal assembly procedures;
   c. reflow according to normal assembly procedures; and
   d. wash/clean according to normal assembly procedures.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method of mounting a surface mount component to a substrate comprising:
forming at least one standoff element in a footprint area on the substrate where the surface mount component will be mounted.

2. The method of claim 1, wherein the substrate is an organic substrate.

3. The method of claim 1, wherein the surface mount component is an interdigitated capacitor.

4. The method of claim 1, wherein the surface mount component is a ceramic chip capacitor.

5. The method of claim 1, wherein the substrate comprises contact pads having exposed areas defined by openings in a solder mask layer.

6. The method of claim 1, wherein the exposed areas of the pads are sized and spaced to align with terminals of the surface mount component.

7. The method of claim 1, wherein:
contact pads on the substrate extend at least partially into the footprint area; and
there is a central portion of the footprint area which is free of contact pads.

8. A standoff structure for spacing a surface mount component from a substrate, comprising:
legend ink printed on the substrate in a footprint are under the surface mount component.

9. The standoff structure of claim 8, wherein the standoff structure has a height which is between 16 μm and 70 μm.

10. The standoff structure of claim 8, wherein the standoff structure has a height which is between 16 μm and 30 μm.

11. The standoff structure of claim 8, wherein:
the standoff structure comprises one or more standoff elements in the form of cylinders or hemispherical solids, or dots.

12. The standoff structure of claim 8, wherein:
the standoff structure comprises four standoff elements disposed at respective four corners of a central portion of the footprint area.

13. The standoff structure of claim 8, wherein:
the standoff structure comprises three standoff elements, two of which are disposed at two corners of one long side of a central portion of the footprint area, the third of which is disposed midway along an opposite long side of the central portion of the footprint area.

14. The standoff structure of claim 8, wherein:
the standoff structure comprises two standoff elements disposed at two opposite sides of the footprint area, for supporting opposite edges of the surface mount component.

15. The standoff structure of claim 8, wherein:
the standoff structure comprises one standoff element, which is a solid structure in the form of a cruciform, disposed in the central portion of the footprint area.

16. The standoff structure of claim 8, wherein:
the standoff structure extends from within the footprint area to without the footprint area.

17. The standoff structure of claim 8, wherein:
the standoff structure extends beyond a central area of the footprint area into a portion of the footprint area which is between two contact pads.

18. A method of increasing standoff height for surface mount components mounted to a laminate, the method comprising:
applying by an image screening process at least one standoff structure in a footprint area on the laminate surface.

19. The method of claim 18, wherein the standoff structure comprises legend ink.

20. The method of claim 18, wherein the standoff structure comprises a filled epoxy and curing agents and is cured by thermal treatment or by exposure to actinic radiation.
